(19) United States
(12) Patent Application Publication
(10) Pub. No.: US 2024/0305541 A1
(43) Pub. Date: Sep. 12, 2024

(54) SYNTHETIC MONITORING ARCHITECTURE IN MULTI-TENANT SYSTEM

(71) Applicant: VMware LLC, Palo Alto, CA (US)

(72) Inventors: Babu Singarayan, Tracy, CA (US); Ranganathan Rajagopalan, Fremont, CA (US); Vijay Talati, Fremont, CA (US)

(21) Appl. No.: 18/118,685

(22) Filed: Mar. 7, 2023

(51) Int. Cl. H04L 41/40

(52) U.S. Cl. CPC H04L 41/40

(57) ABSTRACT

Some embodiments provide a method for monitoring a multi-tenant system deployed in a cloud, at a monitoring service deployed in the cloud. The method deploys a first service instance in the cloud for a first tenant that is based on a monitoring service configuration defined by an administrator of the multi-tenant system. The method collects (i) a first set of metrics of the first service instance and (ii) a second set of metrics of a second, existing service instance deployed in the cloud for a second, existing tenant of the multi-tenant system. The method uses the second set of metrics to determine an effect on the second service instance of the deployment of the first service instance.

### BACKGROUND

Synthetic monitoring is a technique that has been used to test user experience with websites and other online tools to determine when this experience does not line up with expectations so that developers can be warned. These synthetic monitoring applications often simulate user workflows and monitor key performance metrics to ensure that these workflows operate as expected. For a multi-tenant network management system, ensuring user experience quality is still important. However, performing such testing is not as simple as simply simulating a user interaction workflow, and thus requires more complex monitoring.

### BRIEF SUMMARY

Some embodiments provide a novel synthetic monitoring service for a multi-tenant system deployed in a public cloud. The synthetic monitoring service (also referred to herein as a “monitoring service”) deploys a set of services within the multi-tenant system to simulate a deployment for a new tenant, then collects metrics from both the services of this simulated deployment as well as the services deployed for existing (“real”) tenants. The metrics collected from the existing services can be used to determine how much of an effect the deployment and operation of the services for the simulated new tenant have on the operation of the system for the existing tenants (e.g., by comparing the collected values for the metrics of these services to the metrics prior to values collected for the same metrics prior to deployment and/or to prespecified thresholds for the metrics).

In some embodiments, the monitored multi-tenant system is implemented within a container cluster (e.g., a Kubernetes cluster) in a public cloud (e.g., across one or more public cloud datacenters). For instance, in some embodiments, the multi-tenant system is a network management system that executes in the public cloud to manage groups of datacenters (e.g., on-premises datacenters, virtual datacenters implemented in the same or other public clouds, etc.) for multiple different tenants. Such a multi-tenant network management system, in some embodiments, includes both (i) a set of common multi-tenant services and (ii) multiple tenant-specific service instances that each perform a specific set of network management operations for a single group of datacenters of a single tenant. For instance, the common multi-tenant services could include a subscription service, a registration service, a deployment service that handles deployment of the tenant-specific service instances, among other services.

In some embodiments, the tenant-specific service instances include policy management service instances, network flow monitoring service instances, load balancing service instances, etc. Each service instance, in some embodiments, manages a single group of datacenters for a single tenant. In other embodiments, a single service instance may manage multiple groups of datacenters (for the same tenant or for different tenants). Depending on the types of services requested by a tenant for a particular group of datacenters, multiple service instances (of different types) may manage a single group of datacenters. Each of the service instances, in some embodiments, is implemented as a set of microservices (e.g., in the same namespace of the container cluster).

To perform synthetic monitoring of such a system, in some embodiments the system deploys (i) a synthetic monitoring service as one of the common services (i.e., outside of the namespaces of any of the service instances) and (ii) metric collection services within each of the service instances (e.g., within the namespaces of their respective service instances). The metric collection services measure various metrics (e.g., CPU and/or memory usage by the various microservices, transit time for communication with the respective managed datacenters, etc.), for the microservices in their respective service instances and provide these metrics to the synthetic monitoring service. In some embodiments, the synthetic monitoring service also collects metric data from a health monitoring service that performs health monitoring for the service instances.

The synthetic monitoring service also deploys tenant-specific service instances for simulated tenants in the live system (i.e., in the container cluster along with the existing tenant-specific service instances) in order to test the effect of these deployments on the existing service instances. In some embodiments, these service instances for simulated tenants are deployed according to a service configuration specified (e.g., by a network administrator) for the monitoring service. The service configuration may specify, in different embodiments, the type of service instance(s) to be deployed, the number and type of datacenters to be managed, a level of activity (i.e., interactions with the service instance) for the datacenters and simulated user, and other variables so as to simulate potential tenants that might be added to the system. The synthetic monitoring service then initiates a workflow to deploy the service instance(s), onboard datacenters for the simulated tenant, and simulate tenant interactions with the service instances. During this process (both the onboarding process and the continued interactions with the service instance), the various metrics for the newly deployed service instance as well as the for the existing service instances are collected to determine how the performance of these service instances is affected.

In some embodiments, to perform the onboarding of a service instance, the monitoring service first creates the simulated tenant in the system by contacting the cloud service provider (i.e., that hosts the container cluster in which the network management system is implemented) to create an account and obtain authentication tokens for the simulated tenant. The monitoring service then contacts one or more other common services of the network management system (acting as the new tenant) in order to initiate the deployment of one or more new service instances. In addition, the monitoring service contacts a datacenter integration system (e.g., through another common service of the network management system) to initiate the registration of the datacenters that will be managed by the newly deployed service instances. In some embodiments, these datacenters are actual datacenters operated and/or controlled by the administrator (owner) of the network management system. These datacenters can then initiate communication to the newly deployed service instance(s) and communicate with these service instances, behaving like actual tenant-operated datacenters. During the simulation, both the datacenters and the monitoring service (simulating a user) initiate API calls to the service instances and/or the common services to simulate the operations that would be required of the network management system to provide services to an actual user.

To determine whether the simulated tenant has an adverse effect on the operations of the other tenants (and whether the operations of the simulated tenant will be handled adequately), some embodiments use declarative configuration files (e.g., yaml files) for each tenant-specific service instance. In some embodiments, the declarative configuration file for a given service instance of a given tenant is generated based on the service-level agreement for that tenant.

A service-level agreement for a tenant defines various values that the network management system must meet in providing service to the tenant (e.g., a maximum latency for interactions, etc.). Based on this service-level agreement, these contractual values are translated into measurable metrics (service level objects) that are specified in the configuration file for each of the service instances deployed for a tenant. For instance, for a policy management service instance, the configuration file might specify maximum memory and/or CPU usage percentages for the various microservices of the service instance, a number of datacenters that the service instance should be connected with, maximum response times for communication with these datacenters, and other metrics. The configuration file also specifies similar thresholds for other types of service instances. Because the specified thresholds are based on service-level agreements with different tenants, the thresholds may vary between service instances, even for the same type of service instance. The monitoring service then collects values for these metrics as described above and compares the collected metric values to the thresholds specified in the configuration files for the service instances.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and the Drawings is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates the architecture of a cloud-based multi-tenant network management and monitoring system of some embodiments.

FIG. 2 conceptually illustrates a set of nodes in a container cluster, with various microservices of three service instances distributed across these nodes.

FIG. 3 conceptually illustrates the flow of health and metric data within a network management system according to some embodiments.

FIG. 4 conceptually illustrates a process of some embodiments for determining the effect of deploying service instances for a simulated tenant on the operations of service instances for existing tenants.

FIG. 5 conceptually illustrates a network management system implemented within a Kubernetes cluster prior to deployment of service instances for a simulated tenant.

FIG. 6 conceptually illustrates the synthetic monitoring service of FIG. 5 registering a simulated tenant with a cloud service provider, creating a datacenter group, and registering administrator-managed datacenters.

FIG. 7 conceptually illustrates the deployment of a policy manager service instance in the network management system of FIG. 5 for the simulated tenant, as well as the initiation of connections to this policy manager service instance by the administrator-configured datacenters.

FIG. 8 conceptually illustrates the operations in the network management system of FIG. 5 once the policy manager instance has been deployed.

FIG. 9 conceptually illustrates an example of a declarative configuration file for a synthetic monitoring service to use in determining whether various metrics for a set of service instances are in compliance with threshold values.

FIG. 10 conceptually illustrates an example of metrics measured for a policy manager instance prior to and after the deployment of a set of service instances for a simulated tenant.

FIG. 11 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel synthetic monitoring service for a multi-tenant system deployed in a public cloud. The synthetic monitoring service (also referred to herein as a “monitoring service”) deploys a set of services within the multi-tenant system to simulate a deployment for a new tenant, then collects metrics from both the services of this simulated deployment as well as the services deployed for existing (“real”) tenants. The metrics collected from the existing services can be used to determine how much of an effect the deployment and operation of the services for the simulated new tenant have on the operation of the system for the existing tenants (e.g., by comparing the collected values for the metrics of these services to the metrics prior to values collected for the same metrics prior to deployment and/or to prespecified thresholds for the metrics).

In some embodiments, the monitored multi-tenant system is implemented within a container cluster (e.g., a Kubernetes cluster) in a public cloud (e.g., across one or more public cloud datacenters). For instance, in some embodiments, the multi-tenant system is a network management system that executes in the public cloud to manage groups of datacenters (e.g., on-premises datacenters, virtual datacenters implemented in the same or other public clouds, etc.) for multiple different tenants. Such a multi-tenant network management system, in some embodiments, includes both (i) a set of common multi-tenant services and (ii) multiple tenant-specific service instances that each perform a specific set of network management operations for a single group of datacenters of a single tenant. For instance, the common multi-tenant services could include a subscription service, a registration service, a deployment service that handles deployment of the tenant-specific service instances, a health monitoring service (i.e., separate from the synthetic monitoring service), among other services.

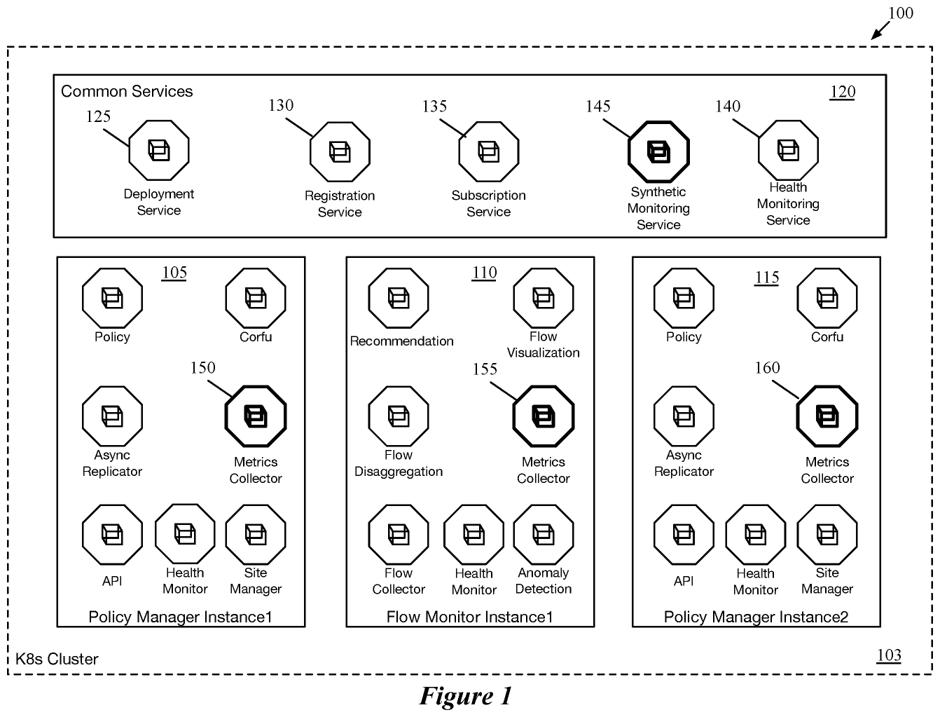

FIG. 1 conceptually illustrates the architecture of such a cloud-based multi-tenant network management and monitoring system 100 (subsequently referred to herein as a network management system) of some embodiments. In some embodiments, the network management system 100 operates in a container cluster (e.g., a Kubernetes cluster 103, as shown). The network management system 100 manages multiple groups of datacenters for multiple different tenants. For each group of datacenters, the tenant to whom that group of datacenters belongs selects a set of network management services for the network management system to provide (e.g., policy management, network flow monitoring, threat monitoring, etc.). In addition, in some embodiments, a given tenant can have multiple datacenter groups (for which the tenant can select to have the network management system provide the same set of services or different sets of services). Additional information regarding these datacenter groups can be found in U.S. Provisional Patent Application 63/440,959, which is incorporated herein by reference.

In some embodiments, each network management service for each datacenter group operates as a separate instance in the container cluster 103. In this example, both a policy management service and a network flow monitoring service have been defined for a first datacenter group, and thus the cluster 103 includes a first policy manager instance 105 and a first flow monitor instance 110. In addition, the policy management service has been defined for a second datacenter group and thus the cluster 105 includes a second policy manager instance 115.

The policy management service for a given datacenter group, in some embodiments, allows the user to define a logical network for the datacenter group that connects logical network endpoint data compute nodes (DCNs) (e.g., virtual machines, containers, etc.) operating in the datacenters as well as various policies for that logical network (defining security groups, firewall rules, edge gateway routing policies, etc.). Operations of the policy manager (in a non-cloud-based context) are described in detail in U.S. Pat. Nos. 11,088,919, 11,381,456, and 11,336,556, all of which are incorporated herein by reference. The flow monitoring service, in some embodiments, collects flow and context data from each of the datacenters in its datacenter group, correlates this flow and context information, and provides flow statistics information to the user (administrator) regarding the flows in the datacenters. In some embodiments, the flow monitoring service also generates firewall rule recommendations based on the collected flow information (e.g., using micro-segmentation) and publishes to the datacenters these firewall rules. Operations of the flow monitoring service are described in greater detail in U.S. Pat. No. 11,340,931, which is incorporated herein by reference. It should be understood that, while this example (and the other examples shown in this application) only describe a policy management service and a network flow monitoring service, some embodiments include the option for a user to deploy other services as well (e.g., a threat monitoring service, a metrics service, a load balancer service, etc.).

The network management system 100 as implemented in the container cluster 103 also includes various common (multi-tenant) services 120, as well as cluster controllers (not shown). These common services 120 are services that are part of the network management system but unlike the service instances are not instantiated separately for each different group of datacenters. Rather, the common services 120 interact with all of the tenant users, all of the datacenter groups, and/or all of the service instances. These services do not store data specific to the network policy or network operation for an individual user or datacenter group, but rather handle high-level operations to ensure that the network management services can properly interact with the users and datacenters.

For instance, the deployment service 125, in some embodiments, enables the creation of the various network management service instances 105-115. In some embodiments, the deployment service 125 is a multi-tenant service that is accessed by (or at least used by) all of the tenants of the network management system. Through the deployment service, a tenant can define a datacenter group and specify which network management services should be implemented for the datacenter group (e.g., by making API calls to the deployment service). In addition, within a datacenter group, in some embodiments the deployment service 125 allows a tenant to define sub-tenants for the group. In other embodiments, sub-tenants may be defined by tenants through other common services not shown in this figure.

The registration service 130 of some embodiments performs a set of operations for ensuring that physical datacenters can register with the network management service. The registration service 130 also keeps track of all of the different datacenters for each datacenter group, in some embodiments. In some embodiments, this latter operation (tracking the datacenters for each group) is performed by a datacenter integration service. The subscription service 135 of some embodiments handles subscription operations. The network management system of some embodiments uses a keyless licensing system; in some embodiments, the subscription service 135 swaps out licenses for datacenters that previously used a key-based licensing mechanism for an on-premises network management system. The health monitoring service 140 performs health monitoring of both the common services and the service instances. In some embodiments, the health monitoring service 140 collects health status data directly from the common services as well as from health monitoring services operating within each of the service instances 105-115, which in turn collect health status data for their respective service instances. It should be understood that the common services 120 illustrated in this figure are not an exhaustive list of the common services of a network management system of some embodiments.

In some embodiments, each of the network management service instances 105-115 of the network management system is implemented as a group of microservices. For instance, in a Kubernetes environment, in some embodiments each of the microservices is implemented in an individual Pod. In some embodiments, each of the service instances 105-115 is assigned a different namespace within the container cluster 103 (with appropriate rules preventing service instances for different datacenter groups from communicating with each other. Each of the network management service instances 105-115 includes multiple microservices that perform different functions for the network management service.

For instance, each of the policy manager instances 105 and 115 includes a policy microservice (e.g., for handling the actual policy configuration for the logical network spanning the datacenter group), a Corfu microservice (e.g., a Corfu database service that stores network policy configuration via a log), an asynchronous replication microservice (e.g., for executing asynchronous replication channels that push configuration to each of the datacenters managed by the policy management service), an API microservice (e.g., for handling API requests from users to modify and/or query for policy), and a site manager microservice (e.g., for managing the asynchronous replication channels).

The flow monitor instance 110 includes a recommendation microservice (e.g., for generating firewall rule recommendations based on micro-segmentation), a flow collector microservice (for collecting flows from the datacenters in the datacenter group monitored by the flow monitor instance 110), a flow disaggregation microservice (e.g., for de-duplicating and performing other aggregation operations on the collected flows), an anomaly detection microservice (e.g., for analyzing the flows to identify anomalous behavior), and a flow visualization microservice (e.g., for generating a UI visualization of the flows in the datacenters). It should be understood that these are not necessarily exhaustive lists of the microservices that make up the policy management and flow monitoring service instances, as different embodiments may include different numbers and types of microservices.

The common services 120 are also implemented as microservices in the container cluster 103 in some embodiments. As shown in this figure, in some embodiments each of the common services is a microservice that is implemented in a Pod. In some other embodiments, some or all of the common services 120 is a group of microservices (like the service instances 105-115).

To perform synthetic monitoring for such a network management system, in some embodiments the system also deploys (i) a synthetic monitoring service 145 as a common service (i.e., outside of the namespaces of the service instances) and (ii) respective metric collection services 150-160 within each of the tenant-specific service instances (i.e., within the namespace of the respective service instance). The metrics collector for a given service instance is responsible for collecting various metrics, either directly from the microservices of that service instance or via observation of the nodes on which those microservices operate. In some embodiments, the metrics collectors 150-160 measure CPU and/or memory usage by the various microservices as well as metrics that are specific to individual microservices (e.g., the response times for communications between the policy microservice of a particular service instance and the datacenters managed by that service instance). The metrics collectors 150-160 provide these metrics to the synthetic monitoring service 145. As will be described in detail below, the synthetic monitoring service 145 deploys tenant-specific service instances for simulated tenants in the live system (i.e., in the container cluster along with the existing tenant-specific service instances) in order to test the effect of these deployments on the existing service instances. The synthetic monitoring service 145 uses the metrics collected prior to, during, and after deployment of a service instance for a simulated tenant to determine the effect that a similar deployment for a “real” tenant will have on the operations of the service instances for existing tenants.

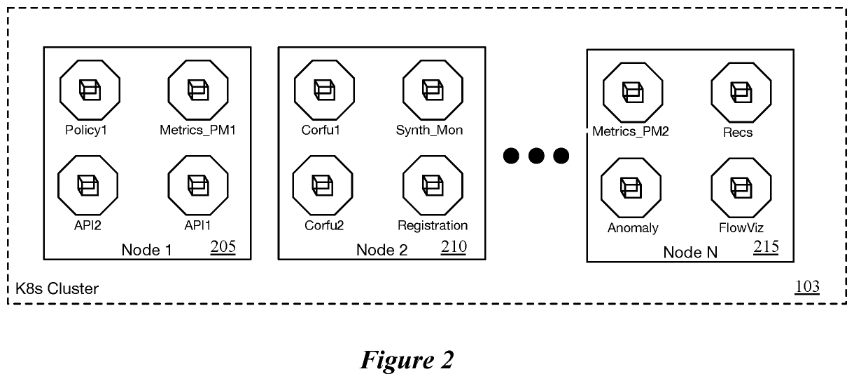

It should be noted that the different microservices within a tenant-specific service instance (as well as the common services) may be placed on various different nodes within the container cluster. FIG. 2 conceptually illustrates a set of nodes 205-215 in the container (Kubernetes) cluster 103, with various microservices of the three service instances 105-115 distributed across these nodes. While this example illustrates four microservices per node, it should be understood that in practice a given node may host many more microservices, and the number of microservices assigned to each node will not necessarily be equal across the nodes.

In some embodiments, each of the nodes 205-215 is a virtual machine (VM) or physical host server that hosts one or more Pods in addition to various entities that enable the Pods to run on the node and communicate with other Pods and/or external entities. These various entities, in some embodiments, include a set of networking resources and network management agents, as well as standard Kubernetes agents such as a kubelet for managing the containers operating in the Pods. Each node operates a set of Pods on which the microservices run. Different embodiments assign a single microservice to each Pod or assign multiple microservices (e.g., that are part of the same service instance) to individual Pods.

In some embodiments, the scheduling of microservices to the different nodes 205-215 is controlled by a set of cluster scheduler components (e.g., a Kubernetes scheduler). As such, each of the nodes 205-215 may host a combination of services (including the synthetic monitoring service and the metric collection services) for various different tenant-specific service instances as well as common services. Thus, for example, the first node 205 hosts two microservices (as well as the metrics collection service) for the first policy manager service instance 105 as well as a single microservice for the second policy manager service instance 115, while the second node 210 hosts one microservice for each of the policy manager service instances 105 and 110 as well as two common services including the synthetic monitoring service 145. In some embodiments, the cluster scheduler component takes into account the relatedness of the microservices (i.e., that they belong to the same service instance) when assigning the microservices to nodes, but this is not necessarily dispositive as the scheduler also accounts for other factors. Thus, the metrics collection services may or may not reside on the same nodes as the various services that they monitor.

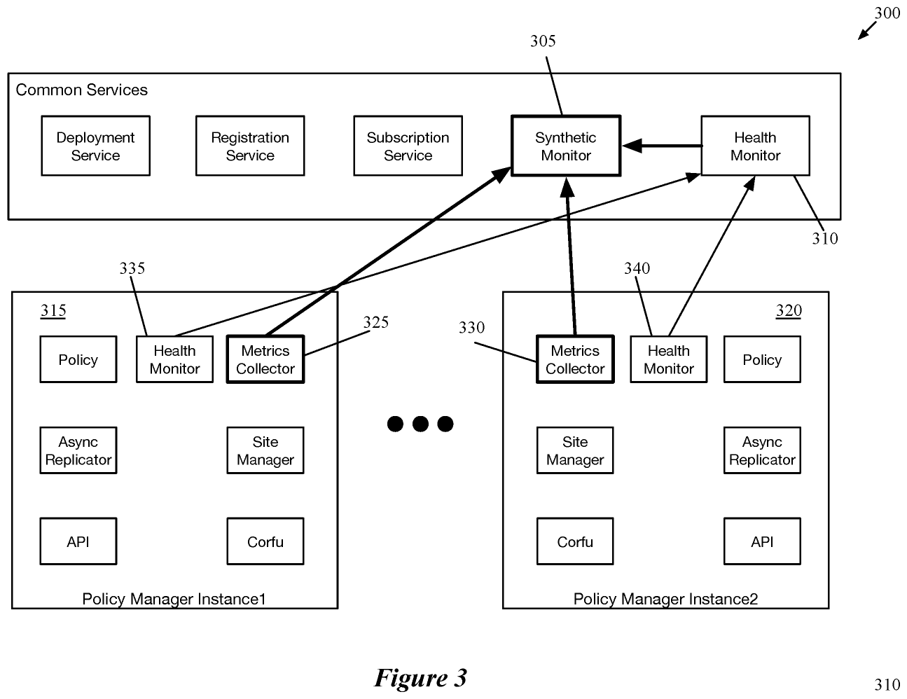

In some embodiments, the synthetic monitoring service collects metric data from the health monitoring service in addition to the metrics collectors. FIG. 3 conceptually illustrates the flow of health and metric data within a network management system 300 according to some embodiments. As shown, metrics collectors 325 and 330 residing respectively in policy manager instances 315 and 320 provide metric data to the synthetic monitoring service 305. The metrics collectors 325 and 330 may collect at least some of this information directly from the microservices of the service instance in some embodiments (e.g., via API calls to the microservices). In some embodiments, the metrics collectors retrieve the metric data from the nodes on which each of the microservices operate (e.g., via API calls to these nodes) and/or via observation of actions taken by the various microservices (e.g., observing round trip time for communications between microservices and the datacenters managed by those service instances).

In addition, health monitoring services 335 and 340 residing respectively in the policy manager instances 315 and 320 collect health data from the microservices in their respective policy manager instances and provide this health data to the health monitoring service 310 that operates as a common service (i.e., outside of the service instance namespaces). In some embodiments, the microservices expose API endpoints for providing customized health status data to their health monitoring service, which the health monitoring services 335 and 340 collect at regular intervals. These health monitoring services 335 and 340 provide the collected health status data to the common health monitoring service 310. In turn, at least a portion of the health status data (e.g., the overall health of various microservices) can be provided to the synthetic monitoring service 305 as metric data used to evaluate the effects of deploying additional service instances for simulated tenants. The health monitoring service 310 also collects health status data directly from the common services in some embodiments, including the synthetic monitoring service 305, though this information is not necessarily provided to the synthetic monitoring service 305.

The synthetic monitoring service also deploys tenant-specific service instances for simulated tenants in the live system (i.e., in the container cluster along with the existing tenant-specific service instances) in order to test the effect of these deployments on the existing service instances. In some embodiments, these service instances for simulated tenants are deployed according to a service configuration specified (e.g., by a network administrator) for the monitoring service. The synthetic monitoring service then initiates a workflow to deploy the service instance(s), onboard datacenters for the simulated tenant, and simulate tenant interactions with the service instances. During this process (both the onboarding process and the continued interactions with the service instance), the various metrics for the newly deployed service instance as well as the for the existing service instances are collected to determine how the performance of these service instances is affected

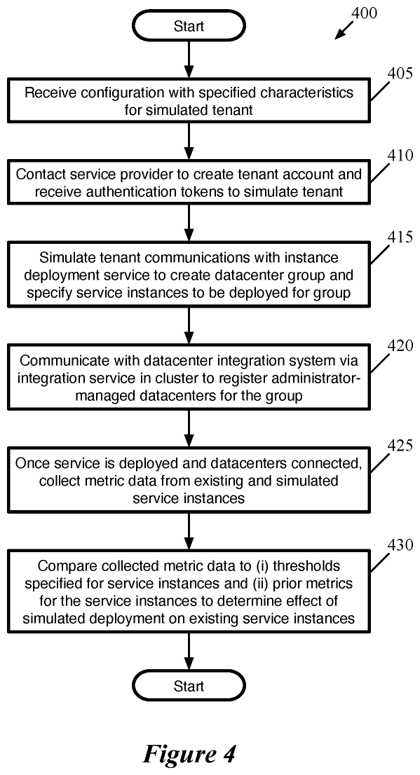

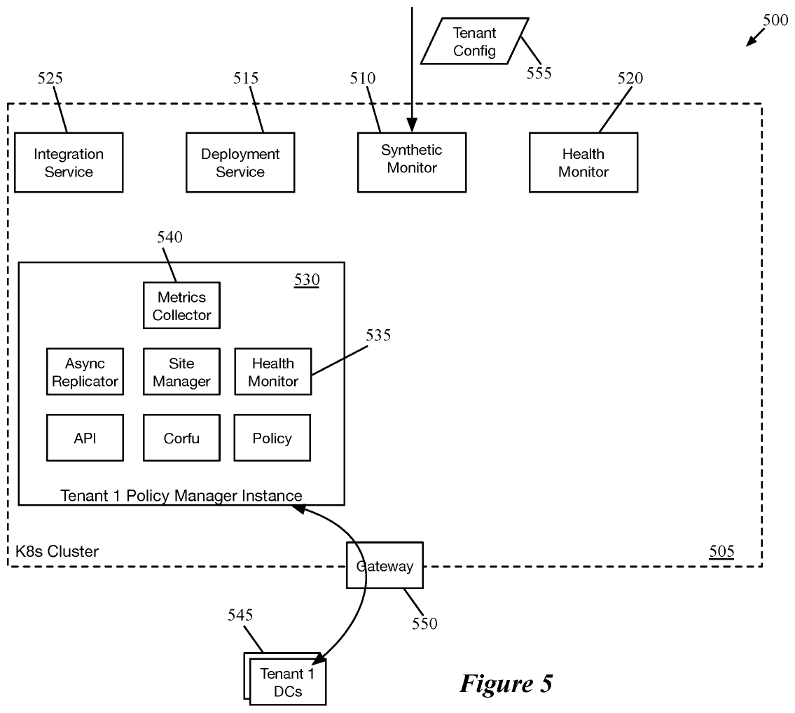

FIG. 4 conceptually illustrates a process 400 of some embodiments for determining the effect of deploying service instances for a simulated tenant on the operations of service instances for existing tenants. In some embodiments, the process 400 is performed by a synthetic monitoring service operating in a network management system in a public cloud (e.g., synthetic monitoring service 305). The process 400 will be described, in part, by reference to FIGS. 5-8, which illustrate the deployment and subsequent operation of a policy manager service instance for a simulated tenant in a network management system.

As shown, the process 400 begins by receiving (at 405) a configuration with specified characteristics for a simulated tenant. In some embodiments, this configuration is received from an administrator that provides the synthetic monitoring service (e.g., via API call) with a set of characteristics of the deployment for the simulated tenant. These characteristics may match (or come close to matching) a potential tenant that may soon be onboarded as a paying tenant of the system or may be generated based on more generic characteristics of potential new tenants. In some embodiments, the synthetic monitoring service is preconfigured with characteristics for different types of tenants (e.g., small, medium, and large), and the system administrator provides the synthetic monitoring service with instructions to deploy a simulated tenant of one of those types. In other embodiments, the synthetic monitoring service is preconfigured with a set of different tenants to simulate at different times, and acts to simulate the operations of these tenants according to this pre-configuration.

FIG. 5 conceptually illustrates a network management system 500 implemented within a Kubernetes cluster 505 prior to deployment of service instances for a simulated tenant. As shown, the network management system 500 includes a synthetic monitoring service 510 as well as other common services: a deployment service 515, a health monitoring service 520, and integration service 525. The integration service 525, in some embodiments, enables communication with a datacenter integration service that operates outside of the cluster 505 to handle certain aspects of datacenter registration.

The network management system 500 also includes a policy manager service instance 530 for an existing tenant. As shown, this policy manager instance 530 includes various microservices (e.g., an asynchronous replication service, a site manager, an API service, Corfu, and a policy service), as described above, as well as a health monitoring service 535 and a metrics collector 540. The policy manager instance 530 manages several datacenters 545 for the tenant, which communicate with the policy manager instance 530 through a gateway 550. In some embodiments, all of the datacenters 545 use the same gateway 550, while in other embodiments different datacenters communicate with the policy manager instance through different gateways (i.e., for ingress into the Kubernetes cluster 505). In some embodiments, as described in detail in U.S. Provisional Patent Application 63/440,959, incorporated by reference above, each datacenter 545 initiates communication with the service instances using authentication tokens and a gateway network address provided when the tenant creates the datacenter group with the network management system. Through the gateway 550, the datacenters 545 and the policy manager service instance 530 can exchange logical network configuration, queries/responses, and other data.

As shown in the figure, the synthetic monitor 510 receives a configuration 555 for a simulated tenant. This configuration 555, as noted previously, may be provided to the synthetic monitor 510 by a network administrator with a command to act as the simulated tenant and deploy a set of service instances in the network management system 500 for a group of datacenters. The configuration 555 specifies various characteristics of the tenant deployment in different embodiments. For instance, the service configuration might specify the type of service instance(s) to be deployed (e.g., policy management, network flow monitoring, anomaly detection, etc.) as well as the number and type of datacenters to be managed. In addition, some embodiments specify the level of activity for the datacenters and the simulated tenant (i.e., the regularity and type of interactions that these entities will have with the service instances specifically and the network management system more generally) as well as other variables that help the synthetic monitoring service 510 to simulate a potential tenant that could be added to the network management system.

Returning to FIG. 4, the process 400 then contacts (at 410) the cloud service provider (i.e., the service provider of the cloud on which the network management system is hosted) to create a customer account for the simulated tenant and receive authentication tokens. The synthetic monitor simulates the tenant interactions with the cloud service provider to create this account. From the cloud service provider, the synthetic monitor receives authentication information that enables the synthetic monitor to simulate the tenant in interactions with other services of the network management system.

Next, the process 400 uses these authentication tokens to simulate (at 415) tenant communications with the instance deployment service (of the network management system) in order to create a datacenter group and specify the service instances to be deployed for the group. In some embodiments, the details of the datacenter group (i.e., the number and type of datacenters in the group) are specified according to the configuration for the simulated tenant. Similarly, the synthetic monitor specifies which service instances should be instantiated for the datacenter group.

The process 400 also communicates (at 420) with a datacenter integration system (via an integration service in the container cluster in which the network management system is implemented) in order to register the datacenters for the group. In some embodiments, these datacenters are administrator-managed datacenters (i.e., are operated by the proprietor of the network management system). In some embodiments, the integration service provides authentication information to the administrator-managed datacenters and receives gateway information from these datacenters (i.e., the gateways at the datacenters that will be used to initiate connection to the network management system. The integration service provides this datacenter gateway information to the synthetic monitor in some embodiments. In addition, if there are multiple gateways in use (e.g., separate gateways for each tenant or each datacenter group), the integration service in the cluster notifies the database integration service as to which gateway the administrator-managed datacenters will use to connect to the service instances, information which can be provided to these datacenters.

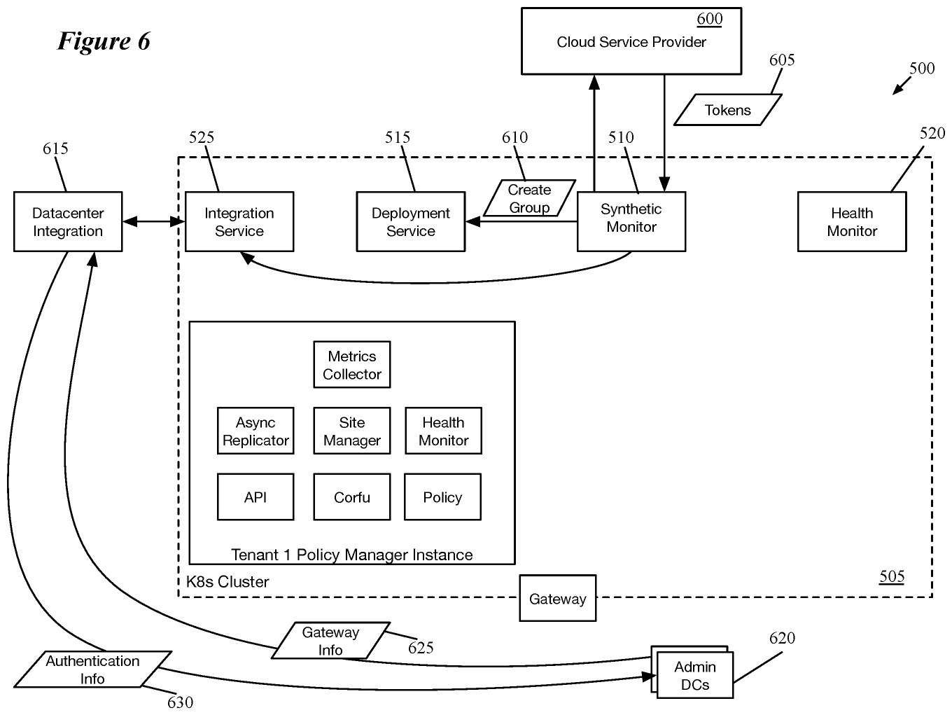

FIG. 6 conceptually illustrates the synthetic monitoring service 510 registering a simulated tenant with the cloud service provider, creating a datacenter group, and registering administrator-managed datacenters. As shown, the synthetic monitoring service 510 contacts cloud service provider 600, which is the cloud service provider hosting the Kubernetes cluster 505 on which network management system 500 is implemented. The synthetic monitoring service 510 provides simulated tenant information to the cloud service provider 600 in order to set up a customer account with the service provider 600. In response, the synthetic monitoring service 510 receives authentication tokens 605, in addition to any other authentication information necessary to contact the network management system services posing as a tenant of the network management system.

The synthetic monitoring service 510 uses this authentication information to communicate with the deployment service 515 and create a datacenter group and specify which services the network management system 500 should perform for this group (i.e., which service instances to deploy). The synthetic monitoring service 510 also specifies the location and/or region in which the service instances should be deployed, in the case that the Kubernetes cluster 505 spans multiple locations or regions of the public cloud in which it is hosted. In some embodiments, this communication appears to the deployment service as an (authorized) API call that would normally come from a user interface for a user located outside of the cluster 505. In some embodiments, the synthetic monitor 510 sends the datacenter group creation command 610 via an ingress service of the cluster 505 (not shown) so that it is received by the deployment service as an external API call. The synthetic monitor 510 also sends a command to deploy specific services for the newly created datacenter group as a separate API command in some embodiments (e.g., via the same mechanism). In other embodiments, this is part of the same API call to the deployment service 515.

The synthetic monitoring service 510, at this stage, also communicates with the integration service 525. In some embodiments, the integration service 525 notifies the synthetic monitoring service 510 as to the gateways located at the datacenters for the (simulated) new tenant that these datacenters will use to connect to the network management system 500. In some embodiments, the integration service 525 retrieves this information from the datacenter integration system 615, which operates outside of the cloud. As shown, this integration system retrieves gateway information 625 from the new administrator-managed datacenters 620 in some embodiments. The datacenter integration system also provides authentication information 630 (e.g., learned from the synthetic monitor 510 via the integration service 525) to these datacenters 620, enabling them to authenticate for communications with the network management system 500.

The administrator-managed datacenters 620 belong to a set of datacenters that are managed by the proprietor of the network management system 500 to use for testing purposes in some embodiments. Like the datacenters of the actual tenants, these administrator-managed datacenters can include a combination of virtual datacenters and physical datacenters. In some embodiments, the virtual datacenters are setup in one or more public clouds by the network management system proprietor for the purpose of being used as datacenters in synthetic monitoring tests. Similarly, the physical datacenters may be simple setups of a small number of host computers with a small number of virtual machines or other data compute nodes in a physical data lab owned by the network management system proprietor. In some embodiments, a number of such physical datacenters are setup in a lab environment for such uses.

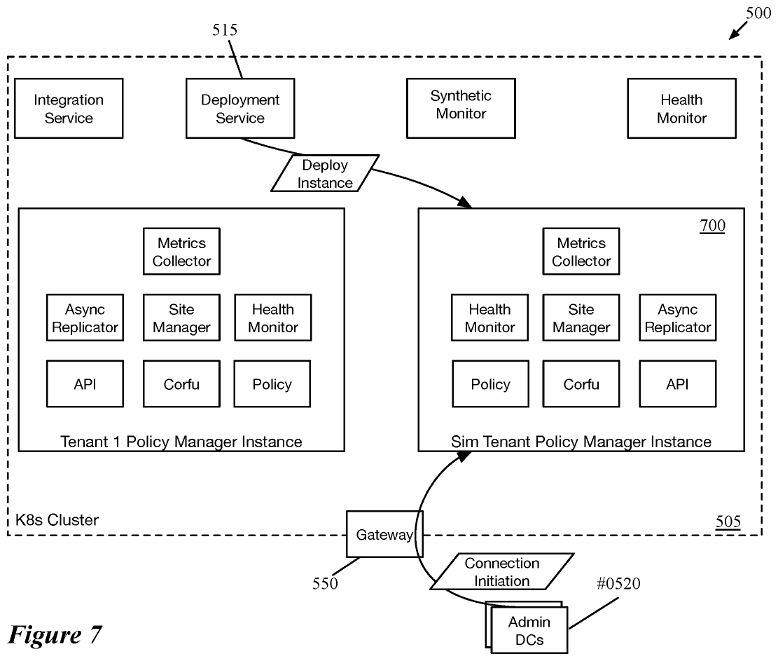

FIG. 7 conceptually illustrates the deployment of a policy manager service instance 700 in the network management system 500 for the simulated tenant, as well as the initiation of connections to this policy manager service instance 700 by the administrator-configured datacenters 620. The deployment service 515, based on the instructions received from the synthetic monitor 510 (as shown in FIG. 6), deploys the specified service instances. In this case, the deployment service deploys only a policy manager instance 700, but the service configuration for a simulated tenant could also include other service instances in some embodiments (e.g., a network flow monitoring instance, an anomaly detection instance, etc.). In some embodiments, to deploy the service instance 700, the deployment service 515 assigns a namespace and directs a Kubernetes controller for the cluster 505 to deploy the various microservices associated with the service instance 700 in that namespace. If the synthetic monitor specifies a particular region and/or cloud location for the service instance, this information is also provided to the Kubernetes controller. The Kubernetes controller then schedules the Pods for these microservices to nodes in the cluster and sets up the inter-instance networking (as well as rules to prevent traffic between, e.g., service instances 530 and 700.

Once the policy manager instance 700 is deployed, the administrator-managed datacenters 620 that belong to the group for which logical network policy is handled by the policy manager instance 700 can initiate connection to the policy manager instance 700. In some embodiments, local network managers at the datacenters 620 begin attempting to initiate this connection once they are provided with the necessary connection information, even if the policy manager instance 700 is not yet setup. Once the policy manager instance 700 is deployed and the gateway 550 configured to allow connections from the datacenters 620 (as noted above, this assumes that all of the datacenters use the same gateway 550 to connect to the network management system 500), the gateway 550 allows the connection initiation requests 705 so that this connection can be initiated. As described in detail in U.S. Provisional Patent Application 63/440,959, which is incorporated by reference above, in some embodiments the datacenters are required to initiate connections with the network management system because they are not publicly reachable. In some embodiments, these connections remain open so that the service instances that manage those datacenters can push commands and/or data onto the connections.

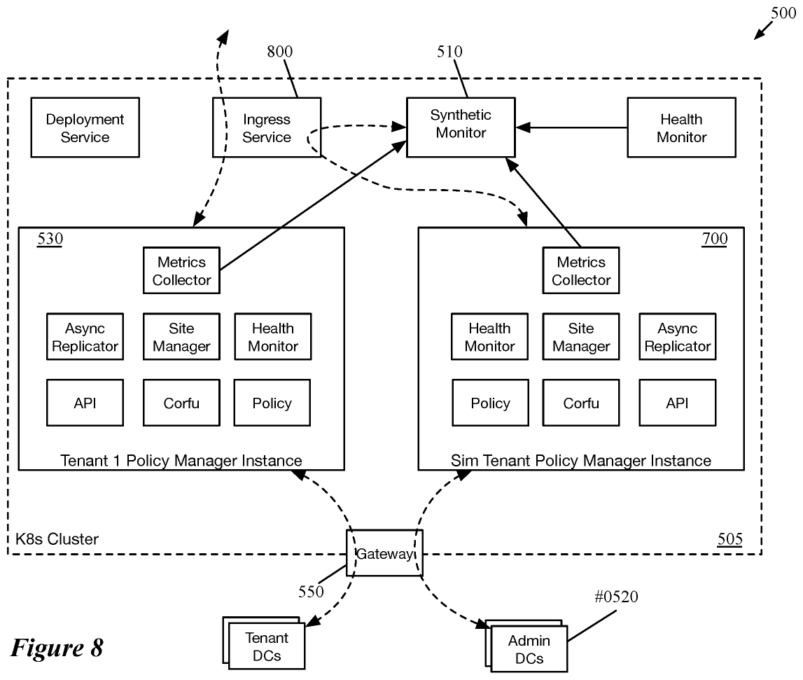

FIG. 8 conceptually illustrates the operations in the network management system 500 once the policy manager instance 700 has been deployed. As shown, the datacenters 545 of the first previously existing tenant communicate with the first policy manager instance 530 while the administrator-managed datacenters 620 communicate with the newly deployed policy manager instance 700. These communications can include the exchange of policy configuration (e.g., the datacenters providing their current policy configurations to their respective policy manager instances in addition to policy configuration changes being pushed down to the datacenters), queries and responses, etc. In addition, via an ingress service 800, external users affiliated with the first tenant (not shown) communicate with the first policy instance 530. Similarly, the synthetic monitoring service 510 simulates tenant interactions with the new policy manager instance 700 for the simulated tenant. These interactions include queries and responses, policy configuration changes, and other communications, some of which result in communication between the respective policy manager instance and one or more of the datacenters managed by that policy manager instance. These communications result in use (and therefore sharing) of the ingress service 800 and the gateway 550, as well as the resources allocated to the various microservices of the respective policy manager instances (which may operate on nodes shared between microservices of different service instances).

Returning again to FIG. 4, once the service instances have been deployed for the simulated tenant and the administrator-managed datacenters connect to the network management system, the process 400 collects (at 425) metric data from the previously existing and simulated service instances. As described above, in some embodiments this data is collected from a combination of (i) metrics collectors deployed in each of the service instances and (ii) health status data from the health monitoring service (which collects health status data from each the health monitoring services in each of the service instances, in some such embodiments).

The process 400 then compares (at 430) the collected metric data for the service instances to (i) thresholds specified for the service instances and (ii) prior metrics for the service instances (i.e., collected prior to the deployment of the service instances for the simulated tenant) to determine the effect of the simulated deployment on the existing service instances and whether the service instances for the simulated tenant perform adequately, then ends. While the comparison to metrics collected prior to the deployment of the simulated tenant's service instances obviously can only be performed for the previously existing service instances, some embodiments compare metrics for both existing service instances and the newly deployed service instances to specified thresholds (which may vary between types of service instance and between tenants).

In some embodiments, the synthetic monitoring service compares the metrics for both the newly deployed service instances and the existing service instances to various thresholds specified in a declarative configuration file. These declarative configuration files, which are described in greater detail below, may be derived from service level agreements for the actual tenants so as to ensure that these service level agreements are met. For the comparison to previously collected metrics, some embodiments calculate the percentage change in the metrics to determine that these changes are not greater than a defined threshold percentage. In some embodiments, the synthetic monitor uses a machine-learning model to perform analysis on the collected metrics and determine whether the deployment of service instances for simulated tenants causes any problems for the existing tenants. In some embodiments, the synthetic monitoring service provides the results of its comparisons to an administrator of the network management system for further analysis. In other embodiments, the synthetic monitoring system only notifies the administrator if there is a violation (either of the specified thresholds or too large a percentage change in a metric).

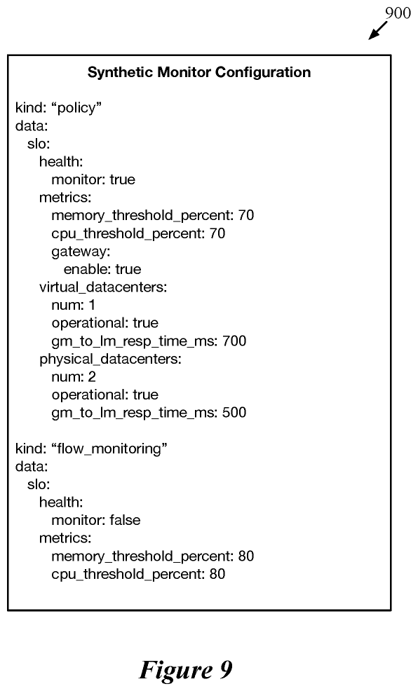

FIG. 9 conceptually illustrates an example of a declarative configuration file 900 for a synthetic monitoring service to use in determining whether various metrics for a set of service instances (in this case, a policy manager instance and a flow monitoring instance) are in compliance with threshold values. In this example, the declarative configuration file 900 is a yaml file, though other similar types of declarative languages can be used instead. In some embodiments, the declarative configuration file 900 is generated based on a service-level agreement for a tenant (i.e., the agreement between the tenant whose datacenters the service instances manage and the proprietors of the network management system). In some embodiments, the synthetic monitoring service uses a similar configuration file for each tenant (or each datacenter group) with service instances deployed in the network management system.

A service-level agreement for a tenant defines various values that the network management system must meet in providing service to the tenant (e.g., a maximum latency for interactions, etc.). Based on this service-level agreement, these contractual values are translated into measurable metrics (service level objects) that are specified in the configuration file for each of the service instances deployed for a tenant.

In this example, the configuration file 900 first specifies for the tenant's policy manager instance that health monitoring service indicate that the service (e.g., all of its microservices) are healthy (e.g., based on the health status data retrieved from those microservices). In addition, the configuration file 900 specifies that, for each microservice, the memory and CPU usage should not be above 70% thresholds. In some embodiments, these usage metrics are measured based on the CPU and memory usage of the node on which the microservice operates (and thus might be increased by the presence of other microservices for the same or other service instances operating on that node). In other embodiments, these usage metrics look at how much of the resources (i.e., the CPU or memory) allocated to a given microservice are currently being used by that microservice. The configuration file 900 also requires that the synthetic monitoring service verify that the gateway is functioning (so that the policy manager instance can communicate with the datacenters that it manages).

The configuration file 900 also specifies metrics for each datacenter managed by the policy instance. Specifically, the file specifies the number of virtual datacenters and number of physical datacenters that the policy manager instance should be in communication with and requires verification that each of these datacenters is operational. Furthermore, the configuration file 900 specifies a response time for communications with each datacenter; in this case, the maximum allowed response time is 700 ms for virtual datacenters and 500 ms for physical datacenters.

For the flow monitoring service instance, the configuration file 900 specifies that the health status data is not required (unlike for the policy manager instance). In addition, the configuration file 900 specifies that, for each microservice, the memory and CPU usage should not be above 80% thresholds. In this case, the configuration file (based on the service level agreement) allows for more leeway in the operation of the flow monitoring instance (as this service is not as critical to datacenter operations as the policy manager instance). Other embodiments require that the health status of the flow monitor microservices be monitored and that the flow monitor service is properly receiving flow data from the datacenters that it monitors.

In this case, the policy manager and flow monitor are the only two service instances deployed for the tenant and thus are the only service instances for which metrics are defined in the configuration file. As indicated above, the network management system of some embodiments includes other services, such as an anomaly detection (network detection and response) service instance. In some embodiments, the configuration file may specify similar metrics for such a service as for the flow monitoring service.

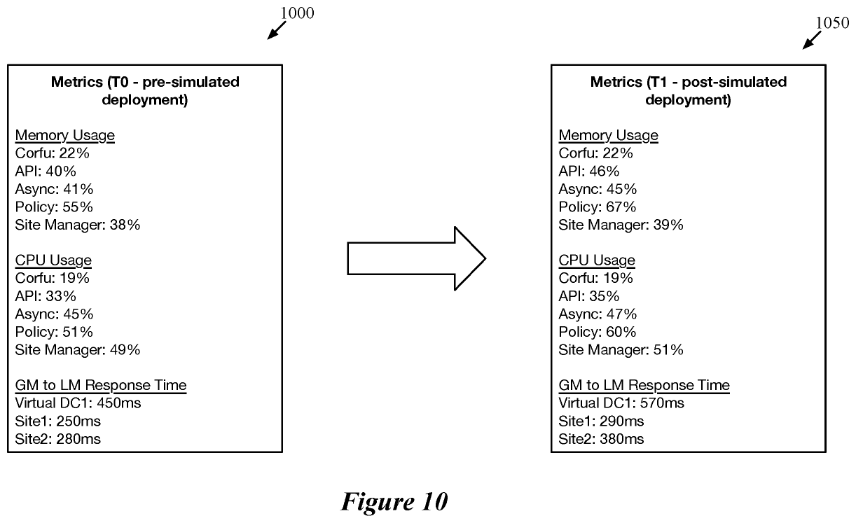

FIG. 10 conceptually illustrates an example of metrics measured for a policy manager instance prior to and after the deployment of a set of service instances for a simulated tenant (e.g., measurements taken at the time of FIG. 5 and subsequently at the time of FIG. 8). As shown, the metrics 1000 in the first stage (prior to deployment of the service instances for a simulated tenant) indicate that the memory and CPU usage of all of the microservices are within compliance (as per the configuration file 900). In addition, the response time of the local managers at three datacenters (one virtual datacenter and two physical datacenters) are within the maximum specified times.

After deployment of the set of service instances for the simulated tenant, the metrics 1050 in the second stage indicate that the memory and CPU usage, as well as the response times for the local managers at the datacenters, remain compliant (as per the specification in the configuration file 900). However, the majority of the metrics do increase (i.e., performance could suffer somewhat, but remain compliant). For instance, the policy microservice increases from 55% to 67% memory usage (nearing the threshold of 70%) while also increasing from 51% to 60% CPU usage. In addition, the virtual datacenter response time has increased to 570 ms. If any of these increases are above a threshold percentage change, then the synthetic monitoring service of some embodiments notifies an administrator (e.g., to allocate additional resources to the policy microservice).

The above description relates to the on-boarding of a set of service instances. In some embodiments, the synthetic monitoring service (after running the services for a simulated tenant for a specified period of time) also performs off-boarding of the service instances, as there is generally not a good reason to leave the service instances operating for an extended period of time, once the testing is complete. To perform this off-boarding, in some embodiments the synthetic monitor oversees a reversal of the on-boarding operations described above. That is, the synthetic monitor disassociates the datacenters with the gateway (and removes the gateway if it is a tenant-specific gateway), removes the datacenters from the network management system inventory, instructs the cluster controller(s) to remove the service instances, and deletes the tenant account from the cloud service provider.

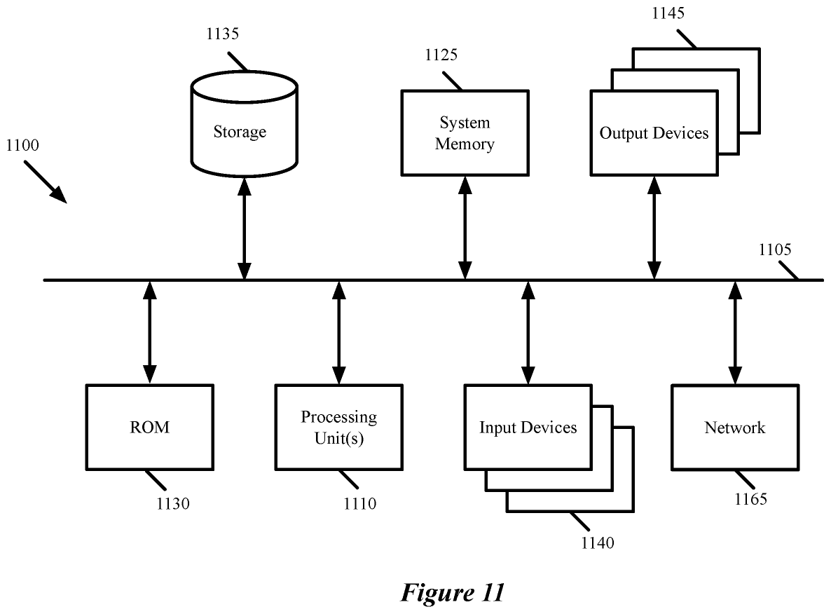

FIG. 11 conceptually illustrates an electronic system 1100 with which some embodiments of the invention are implemented. The electronic system 1100 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 1100 includes a bus 1105, processing unit(s) 1110, a system memory 1125, a read-only memory 1130, a permanent storage device 1135, input devices 1140, and output devices 1145.

The bus 1105 collectively represents all system, peripheral, and chipset buses that communicatively connect the numerous internal devices of the electronic system 1100. For instance, the bus 1105 communicatively connects the processing unit(s) 1110 with the read-only memory 1130, the system memory 1125, and the permanent storage device 1135.

From these various memory units, the processing unit(s) 1110 retrieve instructions to execute and data to process in order to execute the processes of the invention. The processing unit(s) may be a single processor or a multi-core processor in different embodiments.

The read-only-memory (ROM) 1130 stores static data and instructions that are needed by the processing unit(s) 1110 and other modules of the electronic system. The permanent storage device 1135, on the other hand, is a read-and-write memory device. This device is a non-volatile memory unit that stores instructions and data even when the electronic system 1100 is off. Some embodiments of the invention use a mass-storage device (such as a magnetic or optical disk and its corresponding disk drive) as the permanent storage device 1135.

Other embodiments use a removable storage device (such as a floppy disk, flash drive, etc.) as the permanent storage device. Like the permanent storage device 1135, the system memory 1125 is a read-and-write memory device. However, unlike storage device 1135, the system memory is a volatile read-and-write memory, such a random-access memory. The system memory stores some of the instructions and data that the processor needs at runtime. In some embodiments, the invention's processes are stored in the system memory 1125, the permanent storage device 1135, and/or the read-only memory 1130. From these various memory units, the processing unit(s) 1110 retrieve instructions to execute and data to process in order to execute the processes of some embodiments.

The bus 1105 also connects to the input and output devices 1140 and 1145. The input devices enable the user to communicate information and select commands to the electronic system. The input devices 1140 include alphanumeric keyboards and pointing devices (also called “cursor control devices”). The output devices 1145 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 11, bus 1105 also couples electronic system 1100 to a network 1165 through a network adapter (not shown). In this manner, the computer can be a part of a network of computers (such as a local area network (“LAN”), a wide area network (“WAN”), or an Intranet, or a network of networks, such as the Internet. Any or all components of electronic system 1100 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIG. 4) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for monitoring a multi-tenant system deployed in a cloud, the method comprising:
at a monitoring service deployed in the cloud:
obtaining a configuration associated with simulated tenant, the configuration comprises a first service;
deploying the first service instance in the cloud for a first tenant that is based on a monitoring service configuration defined by an administrator of the multi-tenant system; and
collecting (i) a first set of metrics of the first service instance and (ii) a second set of metrics of a second, existing service instance deployed in the cloud for a second, existing tenant of the multi-tenant system; and
using the second set of metrics to determine an effect on the second service instance of the deployment of the first service instance.

2. The method of claim 1, wherein the first tenant is an administrator-created tenant and the second tenant is a paying tenant of the system.

3. The method of claim 1, wherein:
the system is a network management system that executes in a public cloud to manage a plurality of groups of datacenters; and
the network management system deploys a plurality of service instances for a plurality of tenants, each service instance managing one of the groups of datacenters.

4. The method of claim 3, wherein the monitoring service is one of a plurality of services of the network management system deployed outside of the service instances.

5. The method of claim 3, wherein the monitoring service configuration specifies at least (i) a number of datacenters in the group of datacenters managed by the first service instance and (ii) types of datacenters in the group of datacenters.

6. The method of claim 5, wherein the monitoring service configuration further specifies a level of activity for the datacenters in the group of datacenters.

7. The method of claim 3 further comprising monitoring a respective set of metrics of each of a set of the service instances and using the respective sets of metrics to determine effects on the respective service instances of the deployment of the first service instance.

8. The method of claim 1, wherein deploying the first service instance comprises:
communicating with a cloud service provider to create an account for the first tenant and receive authentication information for accessing the system deployed in the cloud; and
using the authentication information to communicate with a deployment service of the multi-tenant system that instantiates the first service instance in the cloud.

9. The method of claim 8, wherein deploying the first service instance further comprises communicating with a group of administrator-managed datacenters that use the authentication information to setup communications with the first service instance.

10. The method of claim 9, wherein the administrator-managed datacenters are preconfigured for use by the monitoring service to simulate tenant-managed datacenters.

11. The method of claim 9, wherein communicating with the group of administrator-managed datacenters comprises communicating with a datacenter integration system that operates outside of the cloud to register datacenters managed by the network management system.

12. The method of claim 9, wherein the group of administrator-managed datacenters initiate API calls to the first service instance that use resources allotted to the network management system.

13. The method of claim 1 further comprising deploying a metric monitoring service in each of the first and second service instances to collect at least a portion of the first and second sets of metrics.

14. The method of claim 13, wherein collecting the first and second sets of metrics comprises collecting portions of the first and second sets of metrics from a health monitoring service that also executes in the cloud as part of the system.

15. The method of claim 1 further comprising collecting a third set of metrics of the second service instance prior to deployment of the first service instance, wherein using the second set of metrics comprises comparing the third set of metrics collected prior to the deployment of the first service instance with the second set of metrics collected after deployment of the first service instance.

16. A non-transitory machine-readable medium storing a monitoring service which when executed by at least one processing unit monitors a multi-tenant system deployed in a cloud, the monitoring service comprising sets of instructions for:
obtaining a configuration associated with simulated tenant, the configuration comprises a first service;
deploying the first service instance in the cloud for a first tenant that is based on a monitoring service configuration defined by an administrator of the multi-tenant system; and
collecting (i) a first set of metrics of the first service instance and (ii) a second set of metrics of a second, existing service instance deployed in the cloud for a second, existing tenant of the multi-tenant system; and
using the second set of metrics to determine an effect on the second service instance of the deployment of the first service instance.

17. The non-transitory machine-readable medium of claim 16, wherein the first tenant is an administrator-created tenant and the second tenant is a paying tenant of the system.

18. The non-transitory machine-readable medium of claim 16, wherein:
the system is a network management system that executes in a public cloud to manage a plurality of groups of datacenters;
the network management system deploys a plurality of service instances for a plurality of tenants, each service instance managing one of the groups of datacenters; and
the monitoring service is one of a plurality of services of the network management system deployed outside of the service instances.

19. The non-transitory machine-readable medium of claim 18, wherein the monitoring service configuration specifies at least (i) a number of datacenters in the group of datacenters managed by the first service instance, (ii) types of datacenters in the group of datacenters, and (iii) a level of activity for the datacenters in the group of datacenters.

20. The non-transitory machine-readable medium of claim 18, wherein the monitoring service further comprises sets of instructions for:
monitoring a respective set of metrics of each of a set of the service instances; and
using the respective sets of metrics to determine effects on the respective service instances of the deployment of the first service instance.

21. The non-transitory machine-readable medium of claim 16, wherein the set of instructions for deploying the first service instance comprises sets of instructions for:
communicating with a cloud service provider to create an account for the first tenant and receive authentication information for accessing the system deployed in the cloud;
using the authentication information to communicate with a deployment service of the multi-tenant system that instantiates the first service instance in the cloud; and
communicating with a group of administrator-managed datacenters that use the authentication information to setup communications with the first service instance.

22. The non-transitory machine-readable medium of claim 21, wherein the administrator-managed datacenters are preconfigured for use by the monitoring service to simulate tenant-managed datacenters.

23. The non-transitory machine-readable medium of claim 21, wherein the set of instructions for communicating with the group of administrator-managed datacenters comprises a set of instructions for communicating with a datacenter integration system that operates outside of the cloud to register datacenters managed by the network management system.

24. The non-transitory machine-readable medium of claim 21, wherein the group of administrator-managed datacenters initiate API calls to the first service instance that use resources allotted to the network management system.

25. The non-transitory machine-readable medium of claim 16, wherein:
the monitoring service further comprises a set of instructions for collecting a third set of metrics of the second service instance prior to deployment of the first service instance; and
the set of instructions for using the second set of metrics comprises a set of instructions for comparing the third set of metrics collected prior to the deployment of the first service instance with the second set of metrics collected after deployment of the first service instance.
